(19) United States
(12) Patent Application Publication
(10) Pub. No.: US 2025/0385825 A1
(43) Pub. Date: Dec. 18, 2025

(54) Turbo Decision Feedback Equalizer and Decoder (TDFED) for Orthogonal Time Frequency Space (OTFS) Communication Systems

(71) Applicant: Lehigh University, Bethlehem, PA (US)

(72) Inventors: Yahong Rosa Zheng, Bethlehem, PA (US); Yukang Xue, Bethlehem, PA (US); Xiyuan Zhu, Bethlehem, PA (US)

(21) Appl. No.: 19/040,633

(22) Filed: Jan. 29, 2025

Related U.S. Application Data
(60) Provisional application No. 63/660,260, filed on Jun. 14, 2024.

(51) Int. Cl. H04L 27/26; H04L 25/03

(52) U.S. Cl. CPC H04L 27/2639; H04L 25/03267; H04L 27/2628

(57) ABSTRACT

This disclosure pertains to procedures, methods, architectures, apparatus, systems, devices, and computer program products for, and/or directed to wireless communications, and particularly to equalization and decoding of Orthogonal Time Frequency Space (OTFS) signals.

### CROSS-REFERENCE TO RELATED APPLICATIONS

This application claims the benefit of priority, under 35 U.S.C. § 119 (e), of U.S. provisional patent application No. 63/660,260, filed Jun. 14, 2024, the entire disclosure of each of which is hereby incorporated herein by reference.

### FIELD

This disclosure pertains to procedures, methods, architectures, apparatus, systems, devices, and computer program products for, and/or directed to wireless communications, and particularly to equalization and decoding of Orthogonal Time Frequency Space (OTFS) signals.

### BACKGROUND

Orthogonal time-frequency space (OTFS) [1] is a two-dimensional modulation technique designed in the delay-Doppler (DD) domain to combat severe Doppler effects and multipath delay spreads in wireless communication channels. OTFS is especially attractive for satellite communication [2]-[5] and UnderWater Acoustic (UWA) communications [6]-[11] as the Doppler spread to carrier frequency ratio is often as high as 10⁻⁴ and the multipath delay spread is on the order of 20-100 taps. The existing OTFS receivers using either time-domain, DD-domain, or cross-domain methods all suffer from high computational complexity or degraded detection performance. For example, the time-domain methods include Maximum A Posteriori Probability (MAP) detection with message passing [12] or minimum mean squared error (MMSE) symbol detection method, both of which experience extremely high computational complexity when the multipath length is greater than 20. The DD-domain channel equalizers include the Sample Matrix Inversion (SMI), the Normalized Least Mean Squares (NLMS), or the Rake receiver with Maximal Ratio Combining (MRC) [13] algorithms, all of which suffer from either high computational complexity or performance degradation. The cross-domain receiver [14] proposes a Turbo detection algorithm that employs a linear equalizer in the time-domain and a maximum likelihood symbol detector in the DD-domain, and then passing messages between the two domains iteratively. The algorithm also suffers from very high computational complexity.

### SUMMARY

In an embodiment, a method of decoding a transmitted Orthogonal Time-Frequency Space (OTFS) signal comprising data, comprises receiving the transmitted OTFS signal; converting the received OTFS signal to baseband; passing the received baseband OTFS signal in the time domain through a set of N feedforward filters to generate N feedforward outputs, where N is a number of Doppler bins in the received OTFS signal; combining the N feedforward outputs into a combined signal; converting the combined signal to the delay-Doppler (DD) domain to generate a DD signal; soft decoding the DD signal; converting the decoded DD signal back into the time-domain; passing the converted time domain signal through N feedback filters to generate N feedback signals; and combining the N feedback signals with the N feedforward outputs; wherein the decoded DD signal comprises the received data.

In another embodiment, an apparatus for decoding a received baseband Orthogonal Time-Frequency Space (OTFS) signal comprising data, comprises: a set of N feedforward filters configured to receive the baseband OTFS signal and to generate N feedforward outputs, where N is a number of Doppler bins in the received OTFS signal and to combine the N feedforward outputs into a combined signal; a Fast Fourier Transform (FFT) module configured to convert the combined signal to a delay-Doppler (DD) domain signal, \tilde{X}^{DD}; a soft decoder configured to decode \tilde{X}^{DD}; a Fast Fourier Transform (FFT) module configured to convert the decoded \tilde{X}^{DD} into the time-domain, \tilde{X}^{DT}; and a set of N feedback filters configured to receive \tilde{X}^{DT} and generate N feedback signals therefrom and combine the N feedback signals with the N feedforward outputs; wherein the output of the soft decoder comprises the received data.

### BRIEF DESCRIPTION OF THE DRAWINGS

A more detailed understanding may be had from the detailed description below, given by way of example in conjunction with the drawings appended hereto. Figures in such drawings, like the detailed description, are exemplary. As such, the Figures and the detailed description are not to be considered limiting, and other equally effective examples are possible and likely. Furthermore, like reference numerals (“ref.”) in the Figures (“FIGs.”) indicate like elements, and wherein:

FIG. 1 is a system diagram illustrating an OTFS system model in accordance with embodiments;

FIG. 2 is a diagram illustrating exemplary transmitted baseband zero-padded OTFS signals in the delay-Doppler, delay-time, and time domains in accordance with exemplary embodiments and the corresponding received baseband zero-padded OTFS signals in the time, delay-time, and delay-Doppler domains in accordance with exemplary embodiments;

FIG. 3 is a system diagram illustrating a Turbo decision feedback equalizer and decoder (TDFED) in accordance with embodiments;

FIG. 4 is a diagram illustrating a data frame in accordance with embodiments;

FIGS. 5A, 5B, and 5C are diagrams illustrating an exemplary experimental transmitted frame (FIG. 5A) and two exemplary corresponding received frames, including a first with high SNR and short multipath echoes, (FIG. 5B) and a second with low SNR and long echoes (FIG. 5C), in accordance with embodiments;

FIG. 6A comprises three graphs illustrating Delay Doppler domain estimated channels after carrier demodulation using Doppler compensation schemes with resolutions set at 0.4 Hz, 2 Hz, and 10 Hz, respectively, in accordance with experimental results;

FIG. 6B comprises three scatter plots illustrating the constellations of OTFS preambles using resolutions set at 0.4 Hz, 2 Hz, and 10 Hz, respectively, in accordance with experimental results; and

FIG. 7 comprises graphs illustrating experimental results of Bit Error Rates (BER) for an OTFS system in accordance with embodiments using TDFED with 0 and 1 iterations, in comparison to an DD-domain NLMS equalizer.

### DETAILED DESCRIPTION

### I. Introduction

Orthogonal time-frequency space (OTFS) [1] is a two-dimensional modulation technique designed in the delay-Doppler (DD) domain to combat severe Doppler effects and multipath delay spreads in wireless communication channels. OTFS is especially attractive for satellite communication [2]-[5] and UnderWater Acoustic (UWA) communications [6]-[11] as the Doppler spread to carrier frequency ratio is often as high as 10⁻⁴ and the multipath delay spread is on the order of 20-100 taps. However, the existing OTFS receivers using either time-domain, DD-domain, or cross-domain methods all suffer from high computational complexity or degraded detection performance. For example, the time-domain methods include either Maximum A Posteriori Probability (MAP) detection with message passing [12] or minimum mean squared error (MMSE) symbol detection method, both of which experience extremely high computational complexity when the multipath length is greater than 20. The DD-domain channel equalizers include the Sample Matrix Inversion (SMI), the Normalized Least Mean Squares (NLMS), or the Rake receiver with Maximal Ratio Combining (MRC) [13] algorithms, all of which either suffer from high computational complexity or performance degradation. For instance, the cross-domain receiver [14] employs message passing between a time-domain equalizer and a DD-domain symbol detector to iteratively solve for optimal decoding. The algorithm also suffers from very high computational complexity.

In accordance with an embodiment of the present invention, a Turbo Decision Feedback Equalizer and Decoder (TDFED) utilizes a set of N feedforward and feedback filters to equalize the received symbol streams in the time domain, where N is the number of Doppler bins in the transmitted OTFS signal. Compared to the DD-domain equalizers, the TDFED equalizer has at least three advantages, namely: 1) better bit error rate performance, 2) lower computational complexity, and 3) potential for parallel processing or pipelining in hardware implementations. Compared to the time-domain linear equalizer in [15], the TDFED has better BER performance in tough multipath channels due to the feedback filter and the added Turbo iterations. It is also worth noting that the Orthogonal Signal Division Multiplexing (OSDM) is mathematically equivalent to OTFS [16]. Therefore, the TDFED scheme also applies to OSDM.

In terms of computational complexity, the NLMS-based DD-domain equalizer has a complexity of O(nᵣₑᵤₛₑM²N²), where nᵣₑᵤₛₑ is the number of data reuses in the iterative NLMS algorithm. In contrast, the TDFED equalizer of the present invention achieves a complexity of O(LMNnᵢₜₑᵣ) or O(L³Nnᵢₜₑᵣ), depending on the channel length L, the block size (M, N), and the number of Turbo iterations nᵢₜₑᵣ. Processing 1,000 OTFS frames, the DD-domain NLMS equalizer takes 2.4 seconds per frame with 8 data reuses, while the TDFED equalizer takes only 0.11 seconds with 1 iteration without parallel processing, highlighting the superior computational efficiency of the TDFED.

### II. The TDFED Algorithm

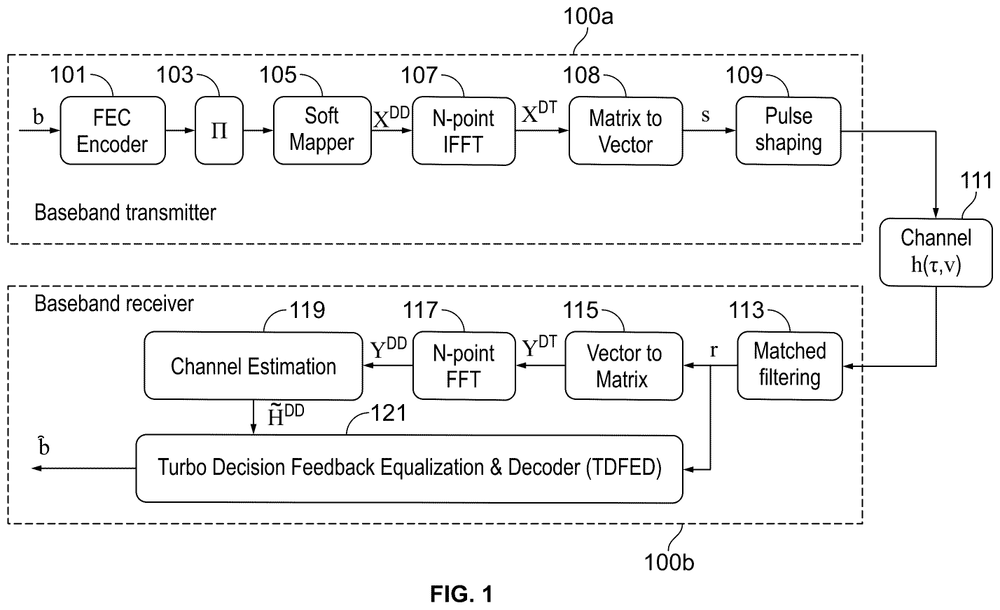

FIG. 1 is a system diagram of an OTFS baseband system, where X^{DD}∈C^{M×N} are the complex symbols in the 2D delay-Doppler domain to be transmitted. The transmitter 100a is shown in the top portion of the FIG., the receiver 100b is shown in the bottom portion, and the channel response shown at 111. Each frame, X^{DD}, consisting of length (M×N) symbols is divided into N blocks with M subcarriers per block. If the subcarrier spacing is Δf, then the block duration is T=1/Δf. The bandwidth and frame duration are B=MΔf and T_{f}=NT, respectively. Consequently, the resolution of path delays and Doppler shifts are 1/(M Δf) and 1/(NT), respectively.

The input data is passed through a Forward Error Correction (FEC) encoder 101 and is then interleaved 103 and soft mapped 105 to the delay-Doppler domain to form signal X^{DD}.

The transmitter 100a converts the delay-Doppler domain symbol matrix X^{DD} into the delay-time domain matrix X^{DT} via an N-point Fast Fourier Transform (FFT) 107 [13], [17]: X^{DT}=X^{DD}F^{†}, where F^{†}_{N} is the N-point inverse FFT (IFFT) matrix. The delay-time matrix X^{DT} is vectorized via Matrix to Vector component 108 and pulse-shaped via pulse shaping filter 109 into the time-domain signal s∈C^{(NM)×1} and transmitted through the channel 111. The baseband equivalent channel impulse response (CIR) is denoted as h(τ, ν) in the delay-time domain and as H^{DD} in the DD domain. The received baseband signal is first matched-filtered 113 to obtain the time-domain signal vector r∈C^{(NM)×1}. The pilot portion of r is inverse-vectorized 115 to yield the delay-time domain matrix Y^{DT}, which is then converted to the delay-Doppler domain as Y^{DD} via N-point FFT 117 for channel estimation 119. The estimated channel matrix, \tilde{H}^{DD}, is converted to the time domain and then fed to the Turbo Decision Feedback Equalizer and Decoder (TDFED) 121. The TDFED 121 takes the time-domain vector r as the input and performs equalization in the time domain directly.

Note that, in order not to obfuscate the invention, transmitter 100a in FIG. 1 is simplified to largely omit the passband components such as the upsampling and carrier modulation steps in the transmitter. It should be understood that a complete and practical system would include such components as a digital up converter (DUC), a pulse width modulator (PWM), and a power amplifier to transmit the passband time-domain signals. Similarly, the receiver system 100b also would normally include unshown passband components, such as an analog-to-digital converter (ADC), a digital down converter (DDC), and a carrier demodulator to obtain the time-domain discrete signal vector r.

In the baseband receiver 100b, the received time-domain signal vector r is usually converted by an inverse vectorization function 115 to the delay-time domain signal matrix

$${Y}^{DT} = {vec}_{m , n}^{- 1} ( r ) , where {vec}_{M , N}^{- 1} ( r )$$

converts r to an M×N matrix. The (m+1, n+1+N/2)-th element of Y^{DD} is the received delay-Doppler symbol expressed as [13], [17], [18]

$${Y}_{n , m}^{DD} = {\sum }_{{m}^{′} = 0}^{M - 1} {\sum }_{{n}^{′} = - N / 2}^{N / 2 - 1} {X}_{{m}^{′} , {n}^{′}}^{DD} {H}_{m - {m}^{′} , n - {n}^{′}}^{DD} {e}^{- j 2 π \frac{ϕ ( m - {m}^{′} , n - {n}^{′} )}{NM}} + {V}_{m , n}^{DD} \qquad ( 1 )$$

where

$${X}_{m , n}^{DD} and {H}_{m , n}^{DD}$$

are the (m+1, n+1+N/2)-th element of X^{DD} and H^{DD}, respectively, for m=0, 1, . . . , M−1 and n=−N/2, . . . , 0, . . . , N/2−1. Note that H^{DD}∈C^{M×N} is the delay-Doppler domain channel impulse response (CIR) matrix. Also, V^{DD} is the additive Gaussian noise in the delay-Doppler domain. The known phase variation

$${e}^{- j 2 π \frac{ϕ ( m - {m}^{′} , n - {n}^{′} )}{NM}}$$

is due to the rectangular pulse-shaping waveforms which require phase compensation. For ideal pulse-shaping waveforms, the phase variation term can be ignored and the input-output relationship in the Doppler domain may be simplified to a standard 2D circular convolution [13], [19]. Since ideal pulse shaping is impossible to achieve in practice, this system uses rectangular pulse shaping and compensates the phase of the received signal at the receiver. The received delay-time domain signal matrix Y^{DT} is usually converted to the received delay-Doppler domain matrix Y^{DD} by an N-point FFT 117

$${Y}^{D D} = {Y}^{D T} {F}_{N} , \qquad ( 2 )$$

where F_{N} denotes the N-point FFT matrix.

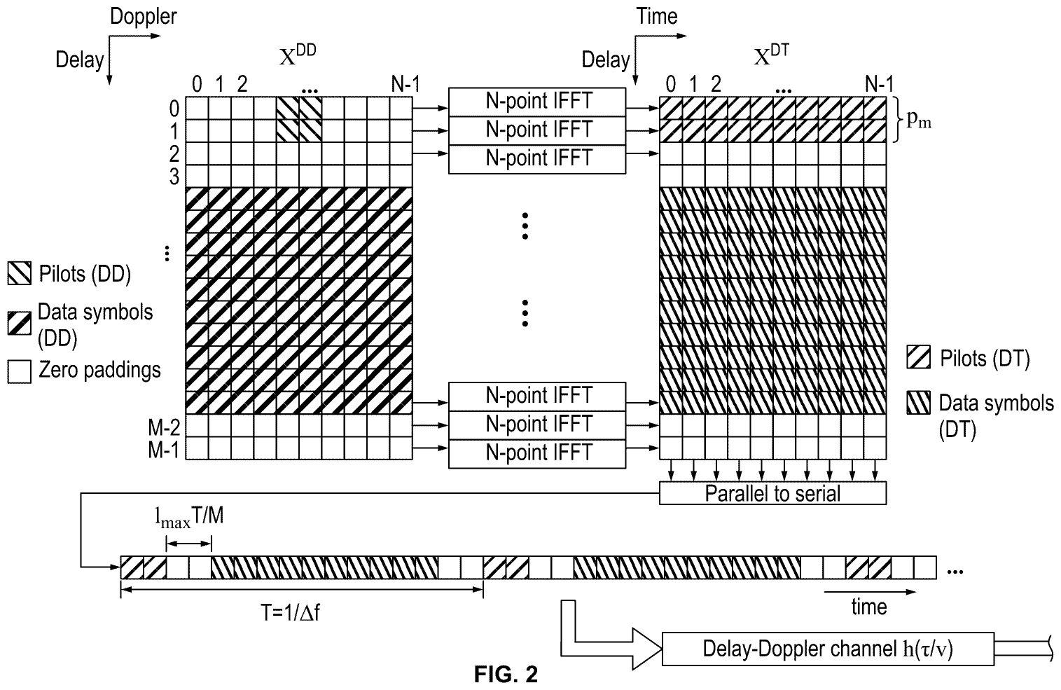

FIG. 2 is a diagram illustrating the structure of exemplary transmit baseband zero-padded OTFS signals in the Doppler domain and the Doppler time domain, respectively, in accordance with embodiments and the corresponding received baseband zero-padded OTFS signals in the delay-Doppler, delay-time, and time domains, respectively. To avoid interference between blocks, the pilots may be zero-padded (ZP) in the OTFS signal, as shown in FIG. 2, where 2lₘₐₓ rows of the transmitted delay-Doppler grid are set to zero, with lₘₐₓ being the maximum index of the channel delay spread. These null symbols remain zeros after the conversion from the delay-Doppler domain to the time domain, thus avoiding interference between the adjacent time-domain blocks. These null symbols are also used as guard intervals between the pilot and transmission payload symbols. In this work, we place a pilot of size (pₘ×pₙ) in the delay-Doppler grid. The pilot comprises a random sequence placed in the middle on the Doppler axis and on the top of the delay axis. In total, the (2lₘₐₓ+pₘ) rows are pilots and guard intervals among all M rows. Therefore, the overhead ratio of the ZP-OTFS structure is (2lₘₐₓ+pₘ)/M. Alternatively, cyclic prefix may be used to replace zero padding.

The time-domain OTFS signal experiences a doubly-selective fading channel h(τ, ν) and the sampled time-domain channel impulse response (CIR) for the nth block and lth tap is denoted g_{n,l}, where n=1, . . . , N,l=0, 1, . . . , L−1, and/is the channel length. The resulting received signals in the time domain, delay-time domain, and DD domain are shown to the right in FIG. 2. Taking advantage of the sparsity of the channel, the OTFS receiver may use the Improved Proportionate Normalized Least Mean Square (IPNLMS) algorithm and the data reuse technique to estimate the channel response in either the time domain or the delay-Doppler domain with a short training pilot sequence. The resulting time-domain channel is assumed to remain unchanged within the data block. Alternately, channel estimation may be achieved directly in the time domain using the pilot signals and may be updated across the payload blocks assuming the symbol decisions are mostly correct.

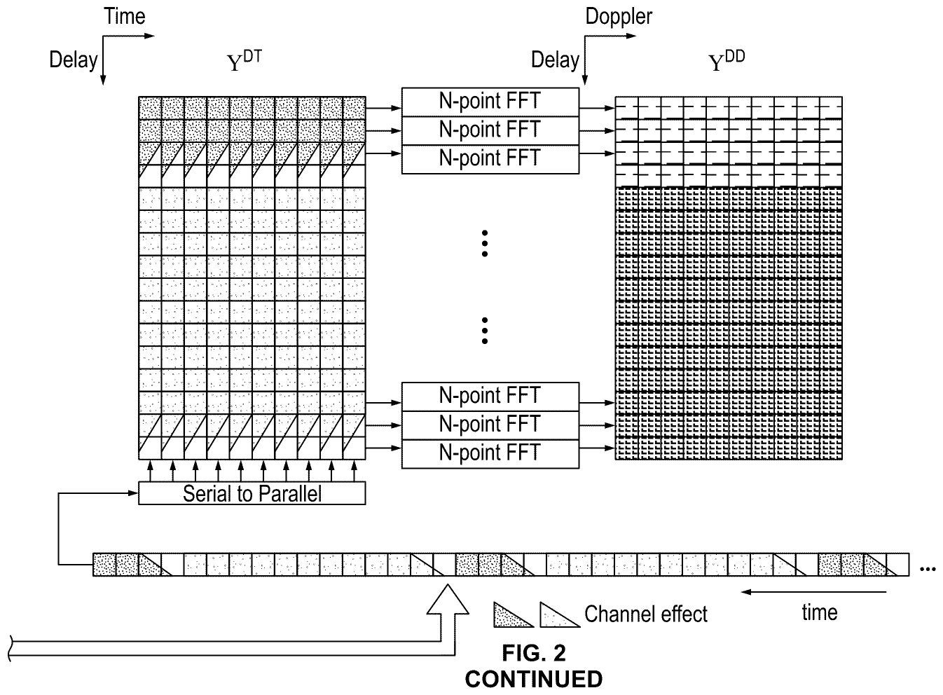

FIG. 3 is a block diagram illustrating the components of an exemplary embodiment of the TDFED 121. For channel equalization, the TDFED 121 comprises of a set of N feedforward filters 301 and N feedback filters 321 in the time domain 333 and a soft decoder 311 (e.g., an LDCP decoder) in the delay-Doppler domain 335. The outputs of the feedforward filters 301 are fed to an FFT 305, soft-demapper 307, and de-interleaver 309 prior to entering the soft decoder 311. The outputs from the soft decoder 311 are interleaved 313 and then soft-mapped 315 into soft symbols which are fed through an IFFT 317 and the N feedback filters 321. The outputs of the feedback filters 321 are combined with the outputs of the feedforward filters 301 to reduce the residual equalization errors.

In accordance with embodiments, the feed forward filters 301 and feedback filters 321 are configured as a function of the channel estimate, \tilde{H}^{DD}, all as described in more detail in the following paragraphs and, particularly, Equations (3) through (9). In particular, \tilde{H}^{DD}, is passed through an IFFT and matrix to vector converter 325 to convert it into the time domain and configure it as a vector, Gₙ, respectively. Then, a filter design function 327 designs the feedforward filters, f_{n,k}, and feedback filters, b_{n,k}, as a function of the time domain channel estimate, Gₙ, the known transmitted symbols, s_{n,k}, and the soft-estimate of the pre-cursor symbols, s̅_{n,k}.

Specifically, the received baseband payload signal in the time-domain is denoted as r∈C^{(N/M)×1} which is grouped into N blocks of length M vectors for each time instant k as r_{n,k}=[r_{n,k-K} r_{n,k-K+1} . . . r_{n,k+K}]^{T}. This corresponds to the transmitted symbols s_{n,k}=[s_{n,k+K-L+1} s_{n,k-K-L+2} . . . s_{n,k+K}]^{T}, where K₁, K₂ are the numbers of filter taps for precursor and post-cursor of the feedforward filters. The kth received signal in the nth block satisfies

$${r}_{n , k} = {G}_{n} {s}_{n , k} + {v}_{n , k} \qquad ( 3 )$$

where the noise vector is

$${v}_{n , k} = {[ {v}_{n , k - K} {v}_{n , k - K + 1} … {V}_{n , k + K} ]}^{T} . \qquad ( 4 )$$

and Gₙ is the channel matrix experienced by the nth block

$${G}_{n} = [ \begin{matrix}{g}_{n , L − 1} & ⋯ & {g}_{n , 0} & ⋯ & 0 \\ ⋮ & ⋱ & ⋱ & ⋱ & ⋮ \\ 0 & ⋯ & {g}_{n , L - 1} & ⋯ & {S}_{n , 0}\end{matrix} ] . \qquad ( 5 )$$

The estimate s\hat{ }_{n,k} of the transmitted symbol s_{n,k} is computed as

$${s}_{n , k} \text{?} = {f}_{n , k} {r}_{n , k} + {b}_{n , k} {\overline{s}}_{n , k} + d \text{?} \qquad ( 6 )$$

$$\text{?} \text{indicates text missing or illegible when filed}$$

where f_{n,k} and b_{n,k} are the feedforward and feedback filters, respectively, and s̅_{n,k} is the soft estimate of pre-cursor symbols after the soft decoder. They are defined as

$$\begin{matrix} & \begin{matrix} & {\overline{s}}_{n , k} = {[ {\overline{s}}_{n , k − K} \text{?} {\overline{s}}_{n , k - K} \text{?} ⋯ {\overline{s}}_{n , k - 1} ]}^{T} ,\end{matrix}\end{matrix} \qquad ( 7 )$$

$${f}_{n , k} = {[ {f}_{n , {K}_{2} , k} {f}_{n , {K}_{2} - 1 , k} ⋯ {f}_{n - {K}_{1} , k} \text{?} ]}^{T} ,$$

$${b}_{n , k} = {[ b \text{?} b \text{?} ⋯ {b}_{n , 1 , k} ]}^{T} ,$$

$$\text{?} \text{indicates text missing or illegible when filed}$$

and K₃ is the number of taps in the feedback filter satisfying K₃=K₂+L−1.

To minimize the mean squared symbol errors E(|s_{n,k}−s\hat{ }_{n,k}|²), the partial differentiation method is used to derive the solution, and the optimal f_{n,k}, b_{n,k}, and d_{n,k} are obtained as

$${f}_{n , k}^{H} = {[ {σ}_{v}^{2} {I}_{K} + {G}_{n} ( {C}_{n , k}^{ff} - {{C}_{n , k}^{fb} ( {C}_{n , k}^{b b} )}^{- 1} {( {C}_{n , k}^{fb} )}^{H} ) {G}_{n}^{H} ]}^{- 1} {Ψ}_{n , k} \qquad ( 8 )$$

$${b}_{n , k}^{H} = - {( {C}_{n , k}^{b b} )}^{- 1} {( {G}_{n} {C}_{n , k}^{f b} )}^{H} {f}_{n , k}^{H}$$

$${d}_{n , k} = E \{ {s}_{n , k} \} - {f}_{n , k} {G}_{n} E \{ {s}_{n , k} \} - {b}_{n , k} E \{ {\overline{s}}_{n , k} \}$$

$$where$$

$${C}_{n , k}^{ff} = E \{ {s}_{n , k} {s}_{n , k}^{H} \} - E \{ {s}_{n , k} \} E \{ {s}_{n , k}^{H} \} \qquad ( 9 )$$

$${C}_{n , k}^{fb} = E \{ {s}_{n , k} {\overline{s}}_{n , k}^{H} \} - E \{ {s}_{n , k} \} E \{ {\overline{s}}_{n , k}^{H} \}$$

$${C}_{n , k}^{bb} = E \{ {\overline{s}}_{n , k} {\overline{s}}_{n , k}^{H} \} - E \{ {\overline{s}}_{n , k} \} E \{ {\overline{s}}_{n , k}^{H} \}$$

$${Ψ}_{n , k} = {G}_{n} ( E \{ {s}_{n , k} {s}_{n , k}^{⋆} \} - E \{ {s}_{n , k} \} E \{ {s}_{n , k}^{⋆} \} )$$

Note that E denotes the expectation operator, superscript H denotes the Hemitian transpose, superscript * denotes conjugate, and superscript−1 denotes matrix inversion. Also, IK is an identity matrix of size K, and σᵥ is the standard deviation of the background noise. Computing f_{n,k}, b_{n,k}, and d_{n,k} for each time instant k leads to high computational complexity. A low-complexity approximation uses the time-invariant equalizer coefficients for all M symbols in one block [21]. This is achieved by taking expectation across all k in each block in Equation (9) yielding the equalizer coefficients fₙ and bₙ for n=1, . . . , N, which are updated in every Turbo iteration. In OTFS systems, the channel variation due to Doppler is captured in different blocks along the N dimension, the channel is considered time invariant within each block, and the low-complexity version is usually well-suited.

In comparison, the conventional DD-domain equalizers of the prior art utilize the DD-domain received signal matrix Y^{DD} and the estimated channel matrix \tilde{H}^{DD} to estimate the symbols X^{DD} such that the mean squared error between the received and reconstructed symbols is minimized. Using the multi-dimensional NLMS algorithm [22], the estimated symbols in the DD-domain are updated as

$${( {\tilde{X}}^{DD} )}^{+} = {\tilde{X}}^{DD} + \frac{{μ ( {W}^{DD} )}^{⋆} {E}_{m , n}^{DD}}{\sum ‖ ( {W}^{DD} ) {‖}^{2} + ϵ} \qquad ( 10 )$$

where \tilde{X}^{DD} and (\tilde{X}^{DD})⁺ represent the estimated symbol matrix and updated estimated symbol matrix, respectively. The parameter μ is the step size which is decreased for each round of data reuse. The parameter ϵ is the regularization parameter. Also, W^{DD}∈C^{M×N} is obtained by adding zeros to the estimated channel \tilde{H}^{DD} and

$${E}_{m , n}^{D D}$$

is the residual error in the DD domain computed as

$${E}_{m , n}^{DD} = {Y}_{m , n}^{DD} − {( {\tilde{h}}^{DD} )}^{H} ( {u}^{DD} ) \qquad ( 11 )$$

where u^{DD}=vec(U^{DD}) whose element

$${U}_{m , {m}^{′} , n - {n}^{′}}^{D D} = {\tilde{X}}_{m - {m}^{′} , n - {n}^{′}}^{DD} {e}^{- j 2 π} \text{?} \qquad ( 12 )$$

$$\text{?} \text{indicates text missing or illegible when filed}$$

is the phase-compensated symbols, and \tilde{h}^{DD}=vec((\tilde{H}^{DD})*), and (⋅)* denotes conjugate and vec( ) denotes matrix vectorization.

### III. Field Experiments and Results

Multiple field experiments have been conducted to evaluate the performance of TDFED for mobile UWA communication. Three lake experiments were done in Lake Nockamixon, Bucks County, PA, during July 2023 and March 2024. One ocean experiment was done in the Atlantic Ocean near Atlantic City, NJ, in May 2024. The average depth of the lake was 15 meters and the average depth of the ocean was 14 meters where the experiments were conducted. The average air temperature of experiment time was 67 degrees Fahrenheit and the average wind speed was 3 miles per hour. The transmitter was anchored at a depth of 10 meter below the water surface and the receiver was towed by a boat or research vessel at an average speed of 1.0 m/s and a maximum speed of 1.5 m/s. Different scenarios were tested with the mobile receiver moving towards or away from the transmitter. The distance between the receiver and the transmitter was 2 meters at the closest and 300 meters at the farthest.

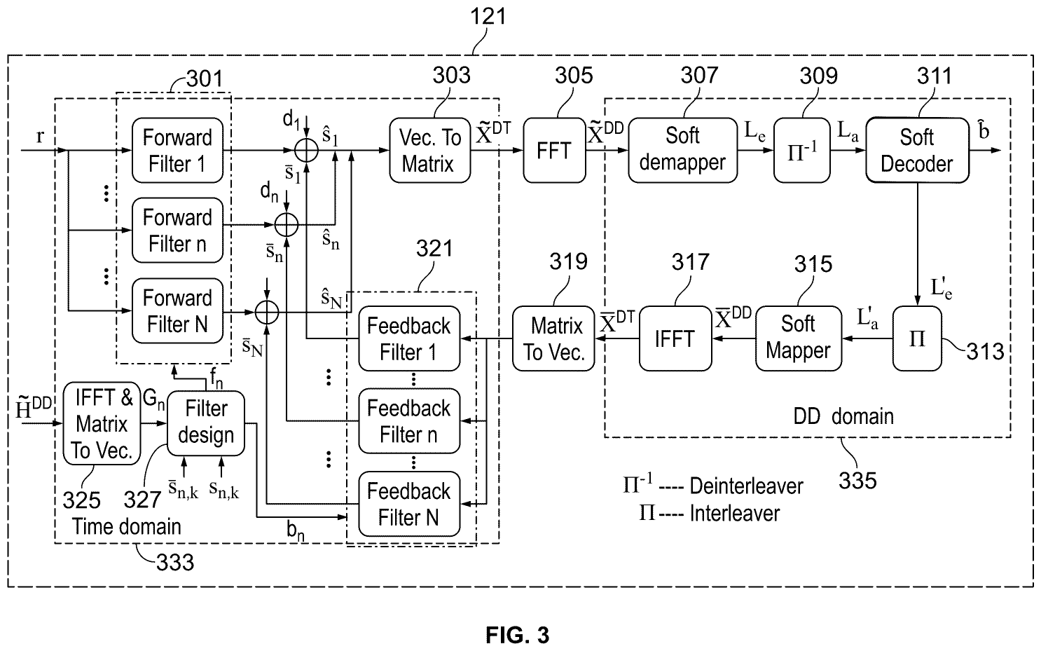

Data frames having the form shown in FIG. 4 were transmitted repeatedly once every second, with each frame consisting of a preamble, a gap, and a payload. The preamble was a 256-bit pseudo-random noise (PN) sequence modulated by Binary Phase Shift Keying (BPSK) symbols. The gap between the preamble and the payload was 50 bits long and was used to prevent the tail of the preamble from interfering with the payload signal. The payloads were symbols of length 2048, 4096, or 8192 which were divided into N blocks. Each block had M symbols in length consisting of a pilot, a gap, and a block of payload data.

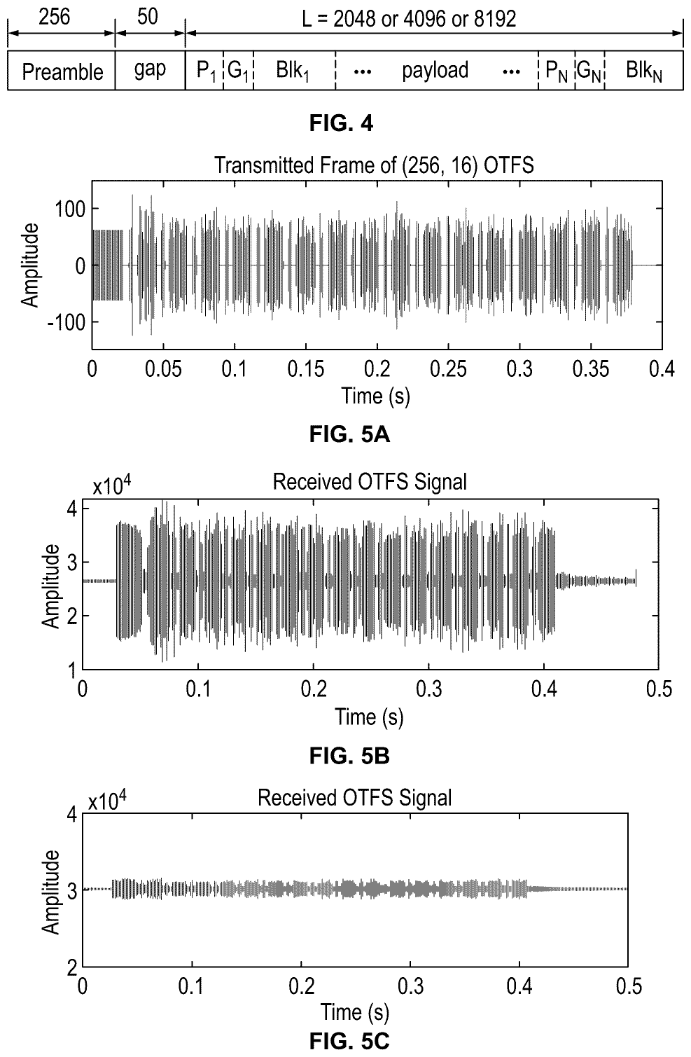

The transmitted information bits (the payload) comprised random binary sequences encoded by a rate 1/2 or 3/4 Low Density Parity Check (LDPC) code with a codeword length of 648. Any non-integer division of the frame length by 648 results in the automatic addition of zeros. The coded bits were interleaved by random permutation and then mapped to PSK symbols. The transmission bandwidth was 11.5 kHz and the carrier frequency was 115 kHz. Carrier modulation was achieved on a Field Programmable Gate Array with a Xilinx Zedboard. The modulated signals were transmitted through a BTech 1201 transducer after a Class-D power amplifier. The receiver hydrophone was also a BTech 1201 and the low-noise-amplifier (LNA) provided bandpass filtering with a 60 dB gain over 35 kHz bandwidth in the passband and 40 dB attenuation in the stopbands. The received signals were recorded with an ADC at a sampling rate of 800 kHz. The carrier demodulated signals were down-sampled to 460 kHz. FIG. 5A shows an example of transmitted passband signals with a payload length of 4096, where the (M, N) value of the OTFS scheme was (256, 16). Note that the OTFS normally has a lower Peak-to-Average Power Ratio (PAPR) than the OFDM (Orthogonal Frequency Division Multiplexing) signals, which is an advantage of OTFS over OFDM.

FIGS. 5B and 5C show two examples of the received signals. One (FIG. 5B) has high SNR and short multipath echoes while the other (FIG. 5C) has low SNR and long echoes.

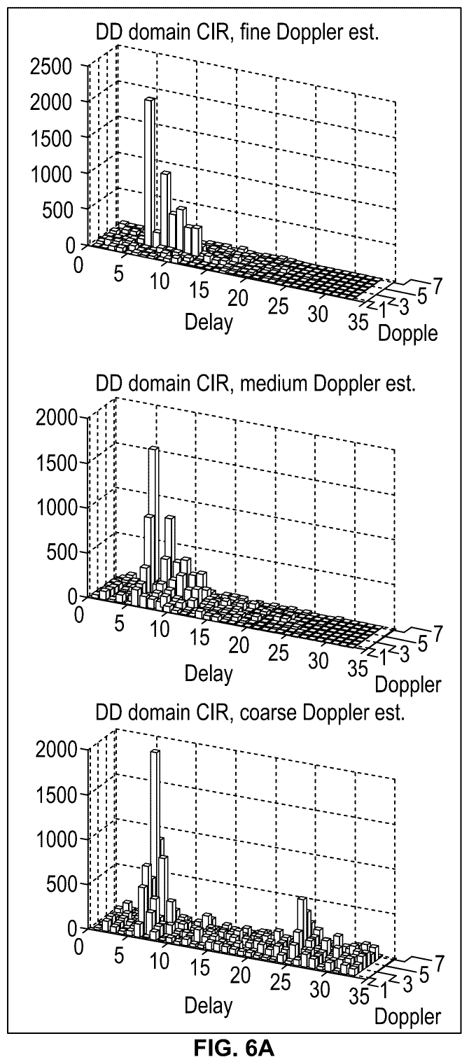

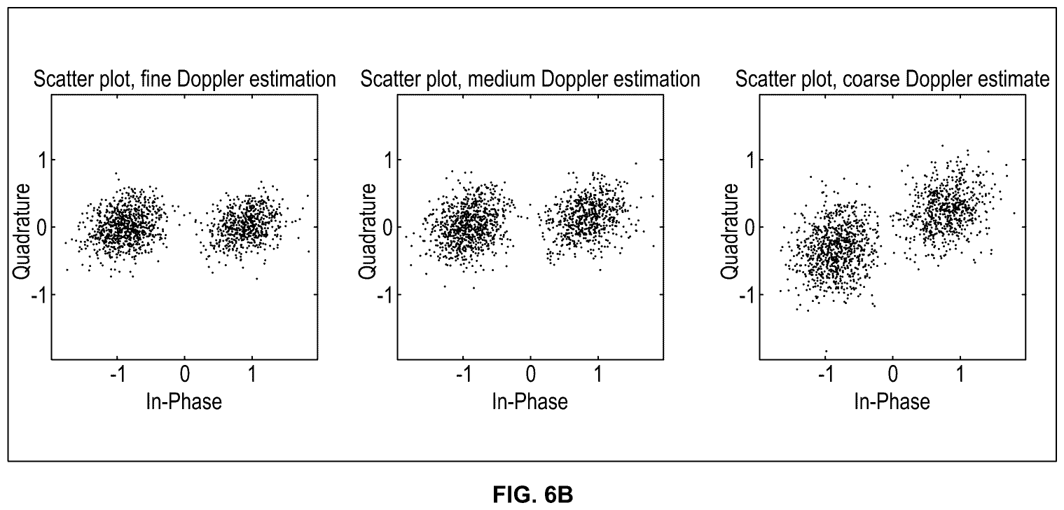

The receiver performance is demonstrated by (i) Doppler compensation, (ii) symbol detection, and (iii) Bit Error Rate (BER). Based on the resolution of a brute-force search around the carrier frequency, Doppler compensation can be categorized into coarse and fine Doppler compensation. FIG. 6A illustrates the DD-domain estimated channels after carrier demodulation using Doppler compensation schemes with resolutions set at 0.4 Hz, 2 Hz, and 10 Hz, respectively. Fine Doppler compensation with a resolution of 0.2 Hz typically results in more accurate channel estimation, but requires increased computational complexity and cost. However, OTFS can combat the residual Carrier Frequency Offsets (CFOs) in the compensated signal by employing coarse Doppler compensation, thus reducing the complexity of Doppler compensation at the passband demodulation. FIG. 6B illustrates the constellations of OTFS preambles using the three types of Doppler compensation schemes. The scatter plots show that at the Doppler resolution of 10 Hz, the BPSK symbols were still decoded very well.

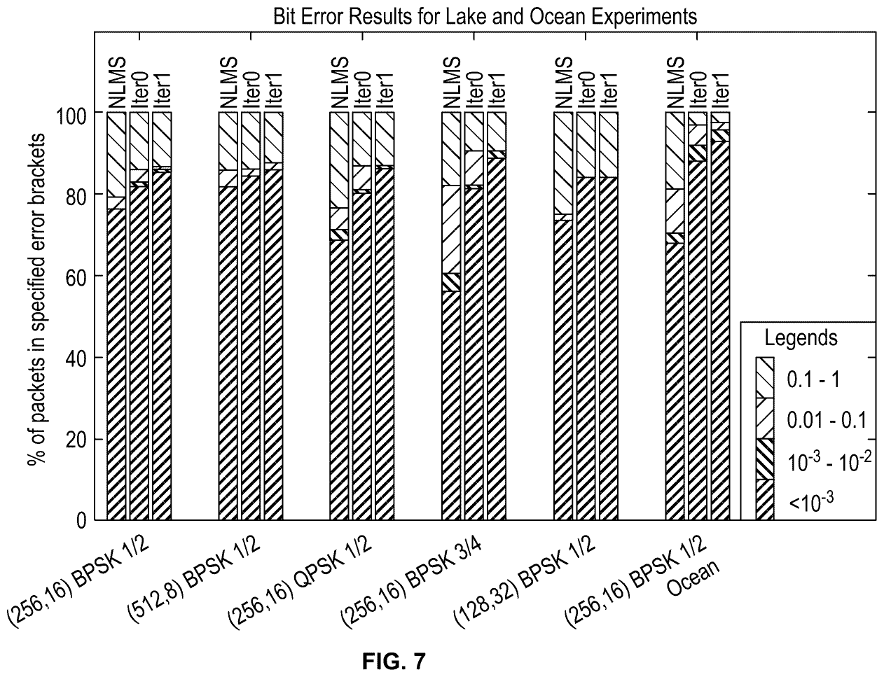

FIG. 7 illustrates the experimental results obtained from the Lake Nockamixon and the Atlantic Ocean experiments. The first 5 column groupings in FIG. 7 show the results from the Lake Nockamixon experiments and the last (rightmost column grouping show the results from the Atlantic Ocean experiments. The experiments tested five different OTFS configurations with distinct parameters: (a) (M, N)=(256, 16), BPSK mapping, code rate 1/2; (b) (M, N)=(512, 8), BPSK mapping, code rate 1/2; (c) (M, N)=(256, 16), QPSK mapping, code rate 1/2; (d) (M, N)=(256, 16), BPSK mapping, code rate 3/4; and (e) (M, N)=(128, 32), BPSK mapping, code rate 1/2. The Lake experiments captured 1500-2000 packets for each configuration. The ocean experiments (rightmost column grouping) captured more than 1200 packets with configuration a). Twelve percent of the packets exhibited an SNR lower than 7.5 dB and were removed from data processing. The receiver data processing used the existing NLMS equalizer in the DD domain and the TDFED of this invention with 0 and 1 iterations. The Doppler resolution for Doppler compensation was 10 Hz.

For each OTFS configuration, the BER distribution using the NLMS equalizer is represented in the leftmost bar, while the BER distributions using the proposed TDFED with 0 and 1 iteration(s) are represented in the middle and rightmost bars, respectively. As can be seen, the TDFED consistently outperforms the DD-domain NLMS equalizer in all scenarios. Moreover, the TDFED with 1 iteration further improved the BER performance in higher modulation order and coding rate. Notably, in configurations (c) and (d) which employ QPSK and 3/4 code rate, respectively, the TDFED reduced the BER of 10⁻³-10⁻¹ to zero for more than 20% of the packets, demonstrating a significant advantage over the DD-domain NLMS equalizer. Throughout the lake experiments, about 12% of the data packets exhibited a persistent high BER in 1-10⁻¹ for all configurations. This occurred when the receiver's boat reached its farthest point and turned around. This inferior performance was due to a rapid channel variation and a significant drop in the Signal-to-Noise Ratio (SNR) during the turning. In contrast, the ocean experiment exhibited good SNR and the results of TDFED were better than the lake experiments.

### CONCLUSION

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

In addition, the methods and components provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed”, “computer executed” or “CPU executed”.

One of ordinary skill in the art will appreciate that the acts and symbolically represented components, operations, or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, components, etc. described herein, such as any of components/blocks/function 101, 103, 105, 107, 109, 113, 115, 117, 119, 121, 301, 303, 305, 307, 309, 311, 313, 315, 317, 319, 321, 325, and 327 in the FIGS., may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions, components, and/or operations, such as any of components/blocks/function 101, 103, 105, 107, 109, 113, 115, 117, 119, 121, 301, 303, 305, 307, 309, 311, 313, 315, 317, 319, 321, 325, and 327 in the FIGS., it will be understood by those within the art that each function, component and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.) and/or “permissive” terms (e.g., the term “is” and/or the term “are” may be interpreted as “may” and/or “might”, the terms “refer(s)” may be interpreted as “may refer” and/or “might refer”, the terms “receive(s)” may be interpreted as “may receive” and/or “might receive”, the terms “support(s)” may be interpreted as “may support” and/or “might support”, the terms “interface(s)” may be interpreted as “may interface” and/or “might interface”, the terms “transmit(s)” may be interpreted as “may interface” and/or “might interface”, “may transmit” and/or “might transmit”, the terms “send(s)” may be interpreted as “may send” and/or “might send”, the terms “does not refer” (and/or the like) may be interpreted as “may not refer” and/or “might not refer”, the terms “does not receive” (and/or the like) may be interpreted as “may not receive” and/or “might not receive”, the terms “does not support” (and/or the like) may be interpreted as “may not support” and/or “might not support”, the terms “does not interface” (and/or the like) may be interpreted as “may not interface” and/or “might not interface”, the terms “does not transmit” (and/or the like) may be interpreted as “may not transmit” and/or “might not transmit”, the terms “does not send” (and/or the like) may be interpreted as “may not send” and/or “might not send”, etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Application Specific Standard Products (ASSPs); Field Programmable Gate Arrays (FPGAs) circuits, any other type of integrated circuit (IC), and/or a state machine.

Although the various embodiments have been described in terms of communication systems, it is contemplated that the systems may be implemented in software on microprocessors/general purpose computers (not shown). In certain embodiments, one or more of the functions of the various components may be implemented in software that controls a general-purpose computer.

In addition, although the invention is illustrated and described herein with reference to specific embodiments, the invention is not intended to be limited to the details shown. Rather, various modifications may be made in the details within the scope and range of equivalents of the claims and without departing from the invention.

### REFERENCES

[1] R. Hadani, S. Rakib, M. Tsatsanis, A. Monk, A. J. Goldsmith, A. F. Molisch, and R. Calderbank, “Orthogonal time frequency space modulation,” in 2017 IEEE Wireless Communications and Networking Conference (WCNC). IEEE, 2017, pp. 1-6.
[2] Q. Tao, T. Xie, Z. Yang, and Z. Zhang, “Symbiotic radio with orthogonal time frequency space modulation over high-mobility channels,” IEEE Transactions on Wireless Communications, vol. 23, no. 12, pp. 18 070-18 082, 2024.
[3] L. Yang, X. Bian, and M. Li, “A novel tabu search detector for OTFS,” IEEE Wireless Communications Letters, vol. 13, no. 12, pp. 3653-3657, 2024.
[4] R. He, X. Zhang, Q. Cui, and X. Tao, “Doppler interference analysis for OTFS-based LEO satellite system,” IEEE Journal on Selected Areas in Communications, vol. 43, no. 1, pp. 75-89, 2025.
[5] Y. Liu, M. Chen, C. Pan, T. Gong, J. Yuan, and J. Wang, “OTFS versus OFDM: Which is superior in multiuser LEO satellite communications,” IEEE Journal on Selected Areas in Communications, vol. 43, no. 1, pp. 139-155, 2025.
[6] X. Feng, H. Esmaiel, J. Wang, J. Qi, M. Zhou, Z. A. Qasem, H. Sun, and Y. Gu, “Underwater acoustic communications based on OTFS,” in 2020 15th IEEE International Conference on Signal Processing (ICSP), vol. 1. IEEE, 2020, pp. 439-444.
[7] M. J. Bocus, A. Doufexi, and D. Agrafiotis, “Performance of OFDM-based massive MIMO OTFS systems for underwater acoustic communication,” IET Communications, vol. 14, no. 4, pp. 588-593, 2020.
[8] L. Jing, N. Zhang, C. He, J. Shang, X. Liu, and H. Yin, “OTFS underwater acoustic communications based on passive time reversal,” Applied Acoustics, vol. 185, p. 108386, 2022.
[9] S. Hang and W. Li, “OTFS for underwater acoustic communications: Practical system design and channel estimation,” in OCEANS 2022, Hampton Roads. IEEE, 2022, pp. 1-7.
[10] Y. Zhang, S. Zhang, B. Wang, Y. Liu, W. Bai, and X. Shen, “Deep learning-based signal detection for underwater acoustic OTFS communication,” Journal of Marine Science and Engineering, vol. 10, no. 12, p. 1920, 2022.
[11] X. Guo, B. Wang, Y. Zhu, Z. Fang, and Z. Han, “Hamming distance optimized underwater acoustic OTFS-im systems,” Entropy, vol. 25, no. 7, p. 972, 2023.
[12] P. Raviteja, K. T. Phan, Y. Hong, and E. Viterbo, “Interference cancellation and iterative detection for orthogonal time frequency space modulation,” IEEE Trans. Wireless Communications, vol. 17, no. 10, pp. 6501-6515, 2018.
[13] T. Thaj and E. Viterbo, “Low complexity iterative rake decision feedback equalizer for zero-padded OTFS systems,” IEEE Trans. Vehicular Technology, vol. 69, no. 12, pp. 15 606-15 622, 2020.
[14] S. Li, W. Yuan, Z. Wei, and J. Yuan, “Cross domain iterative detection for orthogonal time frequency space modulation,” IEEE Transactions on Wireless Communications, vol. 21, no. 4, pp. 2227-2242, 2022.
[15] S. S. Das, V. Rangamgari, S. Tiwari, and S. C. Mondal, “Time domain channel estimation and equalization of CP-OTFS under multiple fractional dopplers and residual synchronization errors,” IEEE Access, vol. 9, pp. 10 561-10 576, 2021.
[16] I. Van der Werf, H. Dol, K. Blom, R. Heusdens, R. C. Hendriks, and G. Leus, “On the equivalence of OSDM and OTFS,” Signal Processing, vol. 214, p. 109254, 2024.
[17] W. Shen, L. Dai, J. An, P. Fan, and R. W. Heath, “Channel estimation for orthogonal time frequency space (OTFS) massive MIMO,” IEEE Trans. Signal Processing, vol. 67, no. 16, pp. 4204-4217, 2019.
[18] P. Raviteja, K. T. Phan, and Y. Hong, “Embedded pilot-aided channel estimation for OTFS in delay-doppler channels,” IEEE transactions on vehicular technology, vol. 68, no. 5, pp. 4906-4917, 2019.
[19] P. Raviteja, Y. Hong, E. Viterbo, and E. Biglieri, “Practical pulse-shaping waveforms for reduced-cyclic-prefix OTFS,” IEEE Transactions on Vehicular Technology, vol. 68, no. 1, pp. 957-961, 2018.
[20] Z. Yang and Y. R. Zheng, “Iterative channel estimation and turbo equalization for multiple-input multiple-output underwater acoustic communications,” IEEE Journal of Oceanic Engineering, vol. 41, no. 1, pp. 232-242, 2016.
[21] M. Tuchler, R. Koetter, and A. Singer, “Turbo equalization: principles and new results,” IEEE Transactions on Communications, vol. 50, no. 5, pp. 754-767, 2002.

1. A method of decoding a transmitted Orthogonal Time-Frequency Space (OTFS) modulated signal comprising data, the method comprising:
receiving the transmitted OTFS signal;
converting the received OTFS signal to baseband;
passing the received baseband OTFS signal in the time domain through a set of N feedforward filters to generate N feedforward outputs, where N is a number of Doppler bins in the received OTFS signal;
combining the N feedforward outputs into a combined signal;
converting the combined signal to the delay-Doppler (DD) domain to generate a DD signal;
soft decoding the DD signal;
converting the decoded DD signal back into the time-domain;
passing the converted time domain signal through N feedback filters to generate N feedback signals; and
combining the N feedback signals with the N feedforward outputs;
wherein the decoded DD signal comprises the received data.

2. The method of claim 1 wherein the converting the combined signal to the delay-Doppler (DD) domain comprises performing a Fast Fourier Transform (FFT) on the combined signal.

3. The method of claim 2 wherein the decoded DD signal back into the time-domain comprises performing an Inverse Fast Fourier Transform (IFFT) on the decoded DD signal.

4. The method of claim 3 further comprising:
match filtering the received OTFS signal.

5. The method of claim 4 wherein the transmitted signal includes a pilot bits portion and the method further comprises:
inverse-vectorizing the pilot portion of the match-filtered received OTFS signal to generate a delay-time domain matrix, Y^{DT};
converting Y^{DT} to the delay-Doppler domain, Y^{DD};
performing channel estimation on Y^{DD} to generate a channel estimate, \tilde{H}^{DD}; and
using \tilde{H}^{DD} to design the N feedforward filters and N feedback filters.

6. The method of claim 5 wherein designing the N feedforward filters and N feedback filters comprises converting \tilde{H}^{DD} by IFFT to a time domain channel estimate g_{n,l}, and forming a Channel Impulse Response (CIR) matrix, Gₙ, therefrom.

7. The method of claim 5 wherein the performing channel estimation comprises using an Improved Proportionate Normalized Least Mean Square (IPNLMS) algorithm to estimate the channel response in the delay-Doppler domain.

8. The method of claim 5 wherein the performing channel estimation comprises:
using the received time-domain baseband pilots and an Improved Proportionate Normalized Least Mean Square (IPNLMS) algorithm to estimate the channel response in the time domain.

9. The method of claim 5 wherein designing the N feedforward filters and N feedback filters comprises:
determining
$${\overline{s}}_{n , k} = {[ {\overline{s}}_{n , k − K} \text{?} {\overline{s}}_{n , k - K} \text{?} ⋯ {\overline{s}}_{n , k - 1} ]}^{T} ,$$
$${f}_{n , k} = [ {f}_{n , {K}_{2} , k} {f}_{n , {K}_{2} - 1 , k} ⋯ {f}_{n - {K}_{1} , k} \text{?} ] ,$$
$${b}_{n , k} = {[ b \text{?} b \text{?} ⋯ {b}_{n , 1 , k} ]}^{T} ,$$
$$\text{?} \text{indicates text missing or illegible when filed}$$
where
f_{n,k} is the feedforward filter function for the nth feedforward filter at time instant k,
b_{n,k} is the feedback filter function for the nth feedback filter at time instant k,
s̅_{n,k} is a soft estimate of pre-cursor symbols after the soft decoding of the DD signals for the nth data block at time k,
K₃ is the number of taps in the feedback filter satisfying K₃=K₂+L−1,
L is the length of the channel impulse response in the time domain, and
K₂ is the number of post-cursor taps of the feedforward filters.

10. The method of claim 9 wherein
$${f}_{n , k}^{H} = {[ {σ}_{v}^{2} {I}_{K} + {G}_{n} ( {C}_{n , k}^{ff} - {{C}_{n , k}^{fb} ( {C}_{n , k}^{b b} )}^{- 1} {( {C}_{n , k}^{fb} )}^{H} ) {G}_{n}^{H} ]}^{- 1} {Ψ}_{n , k}$$
$${b}_{n , k}^{H} = - {( {C}_{n , k}^{b b} )}^{- 1} {( {G}_{n} {C}_{n , k}^{f b} )}^{H} {f}_{n , k}^{H}$$
$${d}_{n , k} = E \{ {s}_{n , k} \} - {f}_{n , k} {G}_{n} E \{ {s}_{n , k} \} - {b}_{n , k} E \{ {\overline{s}}_{n , k} \}$$
$$where$$
$${C}_{n , k}^{ff} = E \{ {s}_{n , k} {s}_{n , k}^{H} \} - E \{ {s}_{n , k} \} E \{ {s}_{n , k}^{H} \}$$
$${C}_{n , k}^{fb} = E \{ {s}_{n , k} {\overline{s}}_{n , k}^{H} \} - E \{ {\overline{s}}_{n , k} \} E \{ {\overline{s}}_{n , k}^{H} \}$$
$${C}_{n , k}^{bb} = E \{ {\overline{s}}_{n , k} {\overline{s}}_{n , k}^{H} \} - E \{ {\overline{s}}_{n , k} \} E \{ {\overline{s}}_{n , k}^{H} \}$$
$${Ψ}_{n , k} = {G}_{n} ( E \{ {s}_{n , k} {s}_{n , k}^{⋆} \} - E \{ {s}_{n , k} \} E \{ {s}_{n , k}^{⋆} \} )$$
and
f^{H}_{n,k} is the filter coefficient vector for the nth feedforward filter at time k,
b^{H}_{n,k} is the filter coefficient vector for the nth feedback filter at time k,
d_{n,k} is the desired symbol in the nth data block at time k,
ŝ_{n,k} is a soft estimate of the transmitted symbols for the nth data block at time k,
σᵥ is the standard deviation of the background noise,
Gₙ is the time-domain channel impulse response matrix for the nth data block,
s_{n,k} is the transmitted symbol vector for the nth data block at time k, and
s*_{n,k} is the conjugate of the symbol for the nth data block at time k

11. The method of claim 1 wherein a frame of the received OTFS signal comprises a delay-Doppler grid having a Doppler axis comprising N columns and a delay time axis comprising M rows, and the received OTFS signal comprises pilot bits with zero-padding or cyclic prefix, wherein 2lₘₐₓ rows of the transmitted delay-Doppler grid are set to zero or filled with cyclic prefix, wherein lₘₐₓ is a maximum index of the channel delay spread.

12. An apparatus for decoding a received baseband Orthogonal Time-Frequency Space (OTFS) radio signal comprising data, the apparatus comprising:
a set of N feedforward filters configured to receive the baseband OTFS signal and to generate N feedforward outputs, where N is a number of Doppler bins in the received OTFS signal and to combine the N feedforward outputs into a combined signal;
a Fast Fourier Transform (FFT) module configured to convert the combined signal to a delay-Doppler (DD) domain signal, \tilde{X}^{DD};
a soft decoder configured to decode \tilde{X}^{DD};
a Fast Fourier Transform (FFT) module configured to convert the decoded \tilde{X}^{DD} into the time-domain, \tilde{X}^{DT}; and
a set of N feedback filters configured to receive \tilde{X}^{DT} and generate N feedback signals therefrom and combine the N feedback signals with the N feedforward outputs;
wherein the output of the soft decoder comprises the received data.

13. The apparatus of claim 12 further comprising:
a matched filter configured to filter the received OTFS signal prior to input to the set of N feedforward filters.

14. The apparatus of claim 13 wherein the received signal includes a pilot bits portion and the apparatus further comprises:
an inverse-vectorizing module configured to receive the pilot portion of the match-filtered received OTFS signal and to generate a delay-time domain matrix, Y^{DT} therefrom;
a Fast Fourier Transform (FFT) module configured to convert Y^{DT} to the delay-Doppler domain, Y^{DD};
a channel estimator configured to perform channel estimation on Y^{DD} to generate a channel estimate, \tilde{H}^{DD}; and
componentry configured to design the N feedforward filters and N feedback filters based on \tilde{H}^{DD}.

15. The apparatus of claim 14 wherein the circuit is configured to design the N feedforward filters and N feedback filters by converting \tilde{H}^{DD} by IFFT to a time domain channel estimate g_{n,l}, and forming a Channel Impulse Response (CIR) matrix, Gₙ, therefrom.

16. The apparatus of claim 14 wherein the channel estimator comprises an Improved Proportionate Normalized Least Mean Square (IPNLMS) module to estimate the channel response in the delay-Doppler domain.

17. The apparatus of claim 14 wherein the channel estimator comprises:
An Inverse Fast Fourier Transform (IFFT) module configured to convert the estimated channel matrix, \tilde{H}^{DD}, to the time domain, \tilde{H}^{DT}; and
an Improved Proportionate Normalized Least Mean Square (IPNLMS) algorithm module configured to estimate the channel response in the delay-time domain.

18. The apparatus of claim 14 wherein the N feedforward filters and N feedback filters comprise componentry for determining
$${\overline{s}}_{n , k} = {[ {\overline{s}}_{n , k − K} \text{?} {\overline{s}}_{n , k - K} \text{?} ⋯ {\overline{s}}_{n , k - 1} ]}^{T} ,$$
$${f}_{n , k} = [ {f}_{n , {K}_{2} , k} {f}_{n , {K}_{2} - 1 , k} ⋯ {f}_{n - {K}_{1} , k} \text{?} ] ,$$
$${b}_{n , k} = {[ b \text{?} b \text{?} ⋯ {b}_{n , 1 , k} ]}^{T} ,$$
$$\text{?} \text{indicates text missing or illegible when filed}$$
where
f_{n,k} is the feedforward filter function for the nth feedforward filter at time instant k,
b_{n,k} is the feedback filter function for the nth feedback filter at time instant k,
s̅_{n,k} is the soft estimate of pre-cursor symbols after the soft decoding of the DD-domain signals for the nth data block at time k,
K₃ is the number of taps in the feedback filter satisfying K₃=K₂+L−1,
L is the length of the channel impulse response in the time domain,
K₂ is the number of post-cursor taps of the feedforward filters,
$${f}_{n , k}^{H} = {[ {σ}_{v}^{2} {I}_{K} + {G}_{n} ( {C}_{n , k}^{ff} - {{C}_{n , k}^{fb} ( {C}_{n , k}^{b b} )}^{- 1} {( {C}_{n , k}^{fb} )}^{H} ) {G}_{n}^{H} ]}^{- 1} {Ψ}_{n , k}$$
$${b}_{n , k}^{H} = - {( {C}_{n , k}^{b b} )}^{- 1} {( {G}_{n} {C}_{n , k}^{f b} )}^{H} {f}_{n , k}^{H}$$
$${d}_{n , k} = E \{ {s}_{n , k} \} - {f}_{n , k} {G}_{n} E \{ {s}_{n , k} \} - {b}_{n , k} E \{ {\overline{s}}_{n , k} \}$$
$$where$$
$${C}_{n , k}^{ff} = E \{ {s}_{n , k} {s}_{n , k}^{H} \} - E \{ {s}_{n , k} \} E \{ {s}_{n , k}^{H} \}$$
$${C}_{n , k}^{fb} = E \{ {s}_{n , k} {\overline{s}}_{n , k}^{H} \} - E \{ {s}_{n , k} \} E \{ {\overline{s}}_{n , k}^{H} \}$$
$${C}_{n , k}^{bb} = E \{ {\overline{s}}_{n , k} {\overline{s}}_{n , k}^{H} \} - E \{ {\overline{s}}_{n , k} \} E \{ {\overline{s}}_{n , k}^{H} \}$$
$${Ψ}_{n , k} = {G}_{n} ( E \{ {s}_{n , k} {s}_{n , k}^{⋆} \} - E \{ {s}_{n , k} \} E \{ {s}_{n , k}^{⋆} \} )$$
and
f^{H}_{n,k} is the filter coefficient vector for the nth feedforward filter at time k,
b^{H}_{n,k} is the filter coefficient vector for the nth feedback at time k,
d_{n,k} is desired symbol in the nth data block at time k,
ŝ_{n,k} is a soft estimate of the transmitted symbols for the nth data block at time k,
σᵥ is the standard deviation of the background noise,
Gₙ is the time-domain channel impulse response matrix for the nth data block,
s_{n,k} is the transmitted symbol vector for the nth data block at time k, and
s*_{n,k} is the conjugate of the symbol for the nth data block at time k.

19. The apparatus of claim 12 wherein a frame of the received OTFS signal comprises a delay-Doppler grid having a Doppler axis comprising n columns and a delay time axis comprising M rows, and wherein the received OTFS signal comprises pilot bits with zero-padding or cyclic prefix, wherein 2lₘₐₓ rows of the transmitted delay-Doppler grid are set to zero or filled with cyclic prefix, wherein lₘₐₓ is a maximum index of the channel delay spread.

20. The apparatus of claim 12 wherein a frame of the received OTFS signal comprises delay-Doppler a grid having a Doppler axis comprising n columns and a delay time axis comprising M rows, and wherein the frame comprises a pilot bit portion of size (pₘ×pₙ), wherein the pilot bit portion comprise a random sequence in the middle on the Doppler axis and on the top of the delay axis.
